(19) United States
(12) Patent Application Publication
(10) Pub. No.: US 2004/0087669 A1
(43) Pub. Date: May 6, 2004

(54) Soft capsules comprising a starch mixture having a reduced degree of branching

(76) Inventors: Stephan Hausmanns, Wiesbaden (DE); Thomas Kiy, Frankfurt am Main (DE); Ivan Tomka, Zurich (CH); Rolf Muller, Zurich (CH)

Correspondence Address: Robert H Hammer III, Suite I, 3121 Springbank Lane, Charlotte, NC, 28226, US

(21) Appl. No.: 10/416,073

(22) PCT Filed: Nov. 8, 2001
(86) PCT No.: PCT/EP01/12935

(30) Foreign Application Priority Data
Nov. 9, 2000 (DE) 100 55 526.8
Apr. 2, 2001 (CH) 0614/01

(51) Int. Cl. C08J 3/02

(52) U.S. Cl. 516/99

(57) ABSTRACT

The invention relates to soft capsules that consist of a gel from a starch mixture having a reduced branching degree and a swelling agent. The soft capsules are especially useful for pharmaceutical, cosmetic and veterinary uses, but also in food technology.

The present invention relates to soft capsules comprising a gel of a starch mixture and a swelling agent, the starch mixture comprising at least one starch component which has a reduced degree of branching compared with native starch, and where the starch mixture can in addition also have native starch.

The use of soft capsules for encapsulating substances which are active pharmacologically, in veterinary medicine, cosmetically or agrochemically has been known for years. Generally, soft capsules are used which, in addition to plasticizers and other common constituents, preferably consist of gelatin. Gelatin is a polypeptide which is principally produced by hydrolyzing the collagen present in the skin and bone of animals. Soft capsules made of gelatin make it possible to encapsulate liquids and solutions of different polarity, they offer protection for sensitive aids and active compounds and permit high variation of possible shapes, colors and sizes. Thus soft capsules are in many ways superior to hard capsules and are frequently used in preference.

Despite these advantages, in the course of problems surrounding the transmissible spongiform encephalopathies (Creutzfeld-Jacob disease, bovine spongiform encephalopathy, scrapie) and on account of the discussion regarding vegetarian alternatives to gelatin-containing soft capsules and dosage forms which comply with “kosher” or “halal” requirements, there arose a requirement for soft capsules which can be produced without using animal proteins, or which consist of raw materials which are not based on animal sources.

Suitable starting materials for producing protein-free soft capsules which have already been described are gels based on carbohydrates.

Gels denote elastic microphases in the swollen state. In this case the elastic microphase is built up by percolation of structural elements which can have molecular or supermolecular dimension and form a spatial network. Gel formation can proceed via a spinodal or growth process. In the second case, a branching process precedes the percolation.

According to Flory & Barett in Disc. Farad. Soc. 57, 1 (1974), four types of gels are differentiated:

1. ordered lamellar structures of mesophases or silicate phases;

2. disordered, covalent, macromolecular networks having branched and linear polymers;

3. macromolecular networks having ordered crosslinking points and disordered regions linking these; and

4. disordered structures of high anisotropic particles, flocculent precipitates and coacervates.

The literature discloses numerous examples as to how carbohydrate-based gels and networks can be used to encapsulate active compounds. Thus Yamada, Watei & Wakao in (JP030986038) describe a process for producing hard capsules and soft capsules consisting of a mixture of cellulose and starch for use in foods and pharmaceutical applications.

The publication WO92/09274 proposes the partial replacement of gelatin in soft capsule production by amylose-enriched starch. U.S. Pat. No. 5,342,626 describes the production of films from carrageenan, gellans and mannans and their use for producing soft capsules. The use of carrageenan at concentrations >5% as gelling agent in the production of soft capsules is also disclosed in WO99/07347. The use of chemically modified starches and celluloses for soft capsule production is discussed in JP93/212706 and WO00/18835. The production of soft capsules based on native (branched) potato starch is described in EP 1 103 254 A.

In addition, it is well known in the subject area that starches and mixtures of starches with other components can be used for producing thermoplastic materials. These are disclosed, for example, in EP 397819, EP 542155, WO 99/02660, WO 99/02595, WO 99/02040. In contrast to these thermoplastic materials, the gels/networks disclosed in the present application do not show free-flowing behavior above the glass transition temperature. In contrast, gels in a plot of temperature against logarithm of Gibb's free energy (log G) exhibit a rubbery elastic plateau.

WO99/02600 of the applicant describes thermoplastic mixtures based on starch and linear water-insoluble poly-α-glucans. Use of these mixtures for producing soft capsules is not mentioned.

The prior art in the production of soft capsules is therefore the use of native, if appropriate chemically or physically modified starches, celluloses and other carbohydrates in combination with other suitable compounds and common plasticizers by various processes known to those familiar with the art.

A disadvantage of the polysaccharide-based soft capsules described to date is their relatively low mechanical strength. The previous soft capsules based on polysaccharides have wall thicknesses which are markedly greater than 100 μm and generally also exceed values of 200-300 μm, which is disadvantageous for some applications and in addition produces a cost disadvantage. In addition, the vegetable raw materials used, owing to their natural origin, are frequently highly heterogeneous, which makes production of uniform soft capsules more difficult.

It was an object of the present invention, therefore, to provide soft capsules which overcome said disadvantages of the prior art.

This object is achieved by the exemplary embodiments described in the patent claims.

In particular, this object is achieved by providing soft capsules comprising a gel of a starch mixture and a swelling agent, where the starch mixture comprises at least one starch component which has a reduced degree of branching compared with native starch, and where the starch mixture can in addition also have native starch, characterized in that at least one starch component has a Dp(N) of >100.

These mixtures are in particular:

Under a first preferred aspect of the present invention mixtures of native starch and non-native biotechnologically produced water-insoluble and linear poly-α-glucans.

Under a second preferred aspect of the present invention mixtures of debranched starches, where the starting starch, before debranching, can originate from one or different sources or can be mixed together.

Under a third preferred aspect of the present invention mixtures of debranched starches and native starches.

Under a fourth preferred aspect of the present invention mixtures of non-native, biotechnologically produced, water-insoluble and linear poly-α-glucans and debranched starches.

Under a fifth preferred aspect of the present invention mixtures of non-native, biotechnologically produced, water-insoluble and linear poly-α-glucans, debranched starches and native starches.

Further preferred illustrative embodiments of the present invention are described in the subclaims which refer back to claim 1.

Under a further preferred aspect of the present invention, the object is achieved by providing soft capsules comprising native starches having a high amylose weight fraction greater than 0.7 (>70% by weight), for example Hylon® VII (National Starch and Chemical Corporation, Wilmington, Del., USA) and Amylogel® 3003 (Blattmann Cerestar AG, Switzerland).

These show very similar values based on Dp(N), f_{crystalline} and degree of branching as do the inventive mixtures and are therefore wholly suitable for the purposes of the present invention.

In addition, a process is provided for producing the soft capsules in which the abovementioned starch components (depending on composition chemically and/or enzymatically debranched starches, native starch and/or non-native, biotechnologically produced, water-insoluble and linear poly-α-glucan) and the swelling agent are homogenized at temperatures >160° C., for example in a chamber kneader. The gel produced is then thermoformed in a suitable processing method, preferably a press or an extruder, to give a sheet, a film or a strip and is then processed to form soft capsules by the rotary die process known per se (J. P. Stanley, Soft Gelatine Capsules; in L. Liebermann et al.: The Theory and of Practice Industrial Pharmacy; Lea & Febiger Philadelphia, 1986).

These soft capsules can comprise, for example, substances which are active pharmacologically, in veterinary medicine, cosmetically or agrochemically, or mixtures of substances.

In addition, the gel, in a preferred embodiment, can comprise substances modifying the odor and/or taste and/or color of the soft capsules and other additives as are customary for the respective application.

The production of gels usable according to the invention using non-native, biotechnologically produced, water-insoluble and linear poly-α-1,4-D-glucan is described in PCT/EP/01/05209 of the applicant, and this application is hereby incorporated in its entirety by reference for the purposes of the present invention.

Debranched starches can be obtained commercially. One example thereof is Novelose® 330 from the National Starch and Chemical Corporation, Wilmington, Del., USA. Debranched starches can also be produced by the action of enzymes such as isoamylase or pullulanase on native starches. These corresponding processes are well known to those skilled in the art. Processes for enzymatic debranching of starches are disclosed, for example, in U.S. Pat. No. 3,730,840; U.S. Pat. No. 3,881,991; U.S. Pat. No. 3,879,212 and U.S. Pat. No. 4,971,723.

Surprisingly, it was found by the abovementioned inventors that the soft capsules produced from an inventive gel have greatly increased strength compared with conventional soft capsules, and numerous advantages associated therewith.

Thus the wall thickness of the soft capsules can be decreased compared with customary polysaccharide-containing products by a factor of 3 to about 100 micrometers, as a result of which the soft capsules can be produced less expensively.

The extensibility of the films, sheets and strips obtained by the thermoforming processes is, at this wall thickness, ≦200%, and the strength at this extension adopts the very high value of ≦5 MPa.

Suitable welding temperature is the range 50-100° C.

Furthermore, glycerol or other hydrophilic polyols can be largely dispensed with as plasticizers, as a result of which the hygroscopicity of the capsules is decreased. As a result, the storage life of the soft capsules and the oxygen barrier function of the soft capsules are affected beneficially.

Compared with current gelatin-containing soft capsules, the disclosed capsules made of biotechnologically produced, water-insoluble, linear poly-α-1,4-D-glucans and starch, in addition to the abovementioned advantages, offer the possibility of setting the water content before extrusion in such a manner that, without further additional drying, they are suitable for further processing by the rotary-die process.

The inventors have surprisingly found that, in the case of the preferred use of non-native, biotechnologically produced, water-insoluble linear poly-α-glucans in the production of the gels, highly order crystalline regions are formed which act as crosslinking points for the disordered starch molecules. Thus a Flory type 3 gel is present, the network density of which, at a comparable degree of swelling, is defined by the relative amount of water-insoluble linear poly-α-glucans. From the network density, the mechanical properties of the gel, such as modulus, elongation and tensile stress at break can be set. Therefore, in the present application, the crystalline properties of biotechnologically produced, water-insoluble linear poly-α-1,4-D-glucan used is advantageously combined with the good processibility of native starch.

The same also applies under a further preferred aspect of the present invention to gels from debranched starches, for example Novelose® 330 and also for mixtures of native starch and debranched starch, or mixtures of native starch, debranched starch and non-native biotechnologically produced, water-insoluble, linear poly-α-glucans.

In the context of the invention, “non-native” means not originating from nature. In particular, in the case of the non-native poly-α-glucan, this means that it is not prepared by chemical or enzymatic modification of native starch.

In the context of the invention, “biotechnologically produced” means the use of biocatalytic processes, also biotransformation processes, or fermentation processes.

In the context of this invention, polyglucan means prepared by biocatalysis (also, biotransformation), so that the polyglucan is prepared by catalytic reaction of monomeric building blocks such as oligomeric saccharides, for example of monosaccharides and/or disaccharides, by using what is termed a biocatalyst, usually an enzyme, under suitable conditions. This is also referred to in this connection as “in-vitro biocatalysis”.

Poly-α-glucans from fermentations are, in the terminology of the invention, poly-α-glucans which can be produced by fermentation processes using organisms occurring in nature, such as fungi, algae, bacilli, bacteria or protists, or can be produced using organisms not occuring in nature, but with the aid of natural organisms modified by generally defined genetic engineering methods such as fungi, algae, bacteria or protists or with the aid of fermentation processes. “In vivo biocatalysis” is also referred to in this context.

Examples of such microorganisms are Piichia pastoris, Trichoderma reseii, Staphylokkus carnosus, Escheria coli or Aspergillus niger.

Advantageous processes for biotechnological production are described, for example, in the applicant's WO 95/31553 and WO99/67412.

According to the processes described there, amylosucrase is added to a sucrose solution, where, with cleavage of the sugar bond, poly-α-glucans and fructose are formed directly.

Other suitable enzymes are polysaccharide synthases, starch synthases, glycol transferases, 1,4-D-glucan transferases, glycogen synthases or phosphorylases.

In contrast to polyglucans which are isolated from natural sources such as plants, the poly-α-glucans which are obtained in this case have a particularly homogeneous property profile, for example in relation to the molecular weight distribution, they contain no unwanted byproducts, or at any rate byproducts only in very small amounts, which need to be removed in a complex manner, or could trigger allergic reactions, and may be reproduced exactly to specification in a simple manner.

Thus, as required, polyglucans having differing properties such as molecular weights etc. can be obtained in a defined manner and readily reproducibly.

Linear polyglucans in the context of the present invention are made up from glucans as monomeric building blocks in such a manner that the individual building blocks are always linked to one another in the same manner. Each base unit or building block thus defined has exactly two linkages, one in each case to another monomer. The only exceptions to this are the two base units which form the start or the end of the polysaccharide. These have only one link to another monomer and form the end groups of the linear polyglucan.

If the base unit has three or more links, this is referred to as branching. What is termed the degree of branching is given by the number of hydroxyl groups per 100 base units that do not participate in the structure of the linear polymer backbone and form the branches.

According to the invention, the non-native, biotechnologically produced, linear and water-insoluble poly-α-glucans have a degree of branching of a maximum of 1%, that is to say they have at most 1 branch per 100 base units. Preferably, the degree of branching is less than 0.5%, and in particular a maximum of 0.1%.

Particular preference is given to non-native, biotechnologically produced, water-insoluble, linear poly-α-glucans whose degree of branching in the 6 position is less than 1%, preferably a maximum of 0.5%, and in particular a maximum of 0.1%, and in the other positions, for example in the 2 or 3 position, is preferably in each case a maximum of 0.5%, and in particular a maximum of 0.1%.

In the case of the likewise preferred use of debranched starches, these have a degree of branching of a maximum of 0.5%, preferably 0.2%, particularly preferably a maximum of 0.3%, and very particularly preferably, a maximum of 0.01%.

In particular, non-native, biotechnologically produced, water-insoluble linear poly-α-glucans which have no branches are suitable for the invention.

In exceptional cases the degree of branching can be so minimal that it is no longer detectable using conventional methods.

For example, the degree of branching can be measured by NMR, but other methods are well known to those skilled in the art.

Furthermore, from a preferred aspect of the present invention, the debranched starches can be linear if they are used in mixtures with native starch.

Examples of preferred linear poly-α-glucans are poly-α-D-glucans where the type of linkage is not critical, provided that linearity within the meaning of the invention is present. A particularly preferred example is linear poly-α-1,4-D-glucan.

For the present invention, the prefixes “alpha” or “D” refer solely to the links which make up the polymer backbone and not to the branches.

Biotechnological and in particular biocatalytic methods have the advantage that the degree of branching can be set in a controllable manner, and in particular water-insoluble linear poly-α-glucans can be obtained directly, for example the preferred poly-α-1,4-D-glucans which contain no branches.

The term “water-insoluble polyglucan” is taken to mean, for the present invention, compounds which, according to the definition of the German Pharmacopiea (DAB=Deutsches Arzneibuch, Wissenschaftliche Verlagsgesellschaft mbH, Stuttgart, Govi-Verlag, Frankfurt, 1987 edition), in accordance with classes 4 to 7, come under the categories “sparingly soluble”, “slightly soluble”, “very slightly soluble” or “practically insoluble” compounds.

Inventively preferred water-insoluble poly-α-glucans may therefore be assigned to class 4 of the DAB, that is to say that a saturated solution of the polyglucan, at room temperature and atmospheric pressure, comprises about 30 to 100 parts by volume of solvent, that is to say water, per part of substance by mass (1 g of substance per 30-100 ml of water). More inventively preferred water-insoluble poly-α-glucans may be assigned to class 5 of the DAB, that is to say that a saturated solution of the polyglucan, at room temperature and atmospheric pressure, comprises about 100 to 1 000 parts by volume of solvent, that is to say water, per part of substance by mass (1 g of substance per 100-1 000 ml of water). Still more inventively preferred water-insoluble poly-α-glucans may be assigned to class 6 of the DAB, that is to say that a saturated solution of the polyglucan, at room temperature and atmospheric pressure, comprises about 1 000 to 10 000 parts by volume of solvent, that is to say water, per part of substance by mass (1 g of substance per 1 000-10 000 ml of water). Most inventively preferred water-insoluble poly-α-glucans may be assigned to class 7 of the DAB, that is to say that a saturated solution of the polyglucan, at room temperature and atmospheric pressure, comprises about 10 000 to 100 000 parts by volume of solvent, that is to say water, per part of substance by mass (1 g of substance per 10 000-100 000 ml of water).

“Very slightly soluble” corresponding to class 6 can be illustrated by the following experimental description:

One gram of the polyglucan under test is heated in 1 l of deionized water to 130° C. at a pressure of 1 bar. The resultant solution only remains stable for a short time over a few minutes. On cooling under standard conditions, the substance precipitates out again. After cooling to room temperature and separation by centrifugation, taking into account the experimental losses, at least 66% of the amount used can be recovered.

For the present invention, the biotechnologically obtained non-native biotechnologically produced, water-insoluble and linear poly-α-glucans can be used as such. If wanted, it can be subjected to an additional treatment.

Thus the non-native, biotechnologically produced, water-insoluble linear polyglucans can be modified, for example by chemically modifying the polyglucans by esterification and/or etherification in one or more positions which do not participate in the linear linkage. In the case of the preferred 1,4-linked poly-α-glucans, the modification can be performed in the 2, 3 and/or 6 position.

Modification in the context of the invention means that the hydroxyl groups present which do not participate in the linkage are chemically modified. This excludes ring-opening of the glucan units, as takes place, for example, in oxidative carboxylation or hydrolysis. Measures for such modifications are extensively known to those skilled in the art.

The poly-α-glucans can be used in the form of what are termed alpha-amylase-resistant poly-α-glucans, as are described in the example of poly-α-1,4-D-glucan in the not [lacuna] patent applications WO 00/02926 and WO 01/42309 of the applicant.

Alpha-amylase-resistant poly-α-glucans can be obtained by preparing a suspension or dispersion of water-insoluble poly-α-glucans and water, heating the suspension or dispersion to a temperature in the range from 50 to 100° C., allowing the paste-like mixture obtained to cool to a temperature in the range of 50° C. to the freezing point, preferably 35 to 15° C., 27 to 22° C., 16 to 0° C., or 6 to 2° C., over a period of 1 to 72 h, preferably 1 to 36 h, and in particular 15 to 30 h, and retrograding the paste-like mixture at a temperature which is reduced compared with the temperature of the heated paste-like mixture in a temperature range of 90 to 4° C., and if appropriate drying or dewatering the resultant product.

In addition, alpha-amylase-resistant poly-α-glucans can be obtained by incubation under water deficit with subsequent cooling and drying. In this case the process can be characterized in that incubation is performed once or repeatedly, in that the process is preferably carried out at a water content of 35%, and in that the incubation is carried out at a temperature which is above the glass transition temperature and below the transition temperature.

The degree of polymerization, that is to say the mean number of glucan units per molecule of the inventively preferably usable debranched starches Dp(N) is preferably >10², particularly preferably >10³, and very particularly preferably >4×10³. If the debranched starch is used in a mixture with native starch and/or non-native, biotechnologically produced, water-insoluble and linear poly-α-glucan, the Dp(N) of the debranched starch can also be below 100.

The Dp(N) of the inventively preferably usable non-native biotechnologically produced water-insoluble linear poly-α-glucans is at least 30, preferably 40 to 300, and very particularly preferably 50 to 100.

Under a further preferred aspect of the present invention, at least one starch component of the inventive starch mixture has a Dp(N) of >10², preferably >10³, and very particularly preferably >4×10³.

In total, in the starch mixture, at least 50% by weight of the at least one starch component having Dp(N) >10² shall be present.

Inventively usable debranched starches are further distinguished by a high weight fraction of crystalline phase which is present after a standardized crystallization operation. For this, 5 g of debranched starch are dissolved in a closed system in 95 g of water at 137° C., kept at this temperature for 3 minutes, the solution is cooled to 22° C., and kept for 48 hours at this temperature at 30% atmospheric humidity. The resultant essentially dry substance is studied by wide-angle X-ray diffraction. The relative scattering intensity is plotted against the scattering angle for 5-35°. The intensity scattering angle function, after deducting the foreign scattering (air, instrument) and the contribution of the thermal vibrations of the scattering molecules (see: U. R. Trommsdorf, I. Tomka, Macromolecules 1995, 28 8(18), 6128-6150), is integrated between the integration limits 5-35° C. and integral termed Iₜₒₜₐₗ. The contribution of the amorphous halo is deduced from the cleaned-up intensity scattering angle function and likewise integrated between the limits mentioned and this integral is termed I_{crystalline}. The ratio I_{crystalline}/Iₜₒₜₐₗ is designated the weight fraction of crystalline phase f_{crystalline}. The crystalline fraction of the debranched starch studied varies in the range 0.1-0.35. f_{crystalline} for native starches having an amylose weight fraction >0.7 is in the range <0.12. For native starches having a weight fraction of amylose <0.7, f_{crystalline} is <0.1.

The weight fraction of the crystalline phase of the debranched starch is f_{crystalline} >0.1, preferably >0.15, particularly preferably >0.2.

The weight fraction of the crystalline phase of the inventive starch mixture is f_{crystalline} >0.05, preferably >0.1, particularly preferably >0.15, and very particularly preferably >0.2.

Regarding the devices which are used in the present invention for producing the capsules, we make reference to the “rotary die process”. The proposed plant consists of a vessel (A) for the aqueous solutions of the modified starch and additives, of a feed line and casting device (B) for the aqueous solution (a), of a conveyor belt (C) onto which the solution is applied from the casting device, of a conveyor belt (C), of a cover (CA) for the conveyor belt (C), of a feed (D) of the film strip solidified by gelation, of a vessel (E) having a feed line wedge (F) for the liquid to be charged into the capsules, of a liquid pump for transporting the filling between (E) and (F) and of two counter-rotating shaping rolls (G), having in each case capsule-half-shaped recesses for receiving the shaped strips. Elevated rims on the recesses ensure the application of pressure on welding and stamping out the capsules. Temperature and conveying action of parts (A) to (G) are controllable by open-loop and closed-loop systems.

The production process for forming welded, one-part solid capsules, in particular the operation for producing the film strips for the soft capsule casings and the filling operation, make a number of requirements of raw material properties. The film strips are frequently produced from a homogeneous molecular dispersion of the capsule casing material, by casting and cooling. An indispensable requirement of the casting solution is that this forms elastic gel phases in a useful time after reducing its temperature to a critical value. The sheeting strips are then conducted to the cooling zone between rotating shaping rolls, extended, filled, welded and the capsules stamped out. The elongation in the shaping of the sheet strips is 0.85 to 1.0, depending on the capsule shape to be achieved. In the shaping of the sheeting strips, tensile stresses are formed, depending on the modulus of the strips, in the range 0.1 to 10 MPa. For the usability of the sheeting strips, the condition applies that their elongation at break and tensile stress at break are in each case greater than the above listed elongation (0.85) and tensile stress (0.1-10 MPa). In order to improve their storage life, the capsules are dried.

In the present invention, to produce the capsules from debranched starches or the also preferably usable non-native, biotechnologically produced, water-insoluble and linear poly-α-glucans, the following production process parameters were developed:

Weight fraction of the starches used in the solutions (B) is >0.01, but <0.5, advantageously >0.1 but <0.3.

The starches and additives used are dissolved in water at a temperature of 50<T₁<180° C., advantageously at the temperature of 50<T₁<100° C.

The setting of the temperature (Tₐ) of the casting solution (a), of the temperature (T_{C}) of the casting support (C) and of the ambient air under the cover (CA), of the temperature of the film strips (T_{f}) before feed to the shaping rolls, of the temperature (Tₖ) of the feed line wedge (F) and the temperature (T_{w}) of the shaping rolls is a significant component of the process for producing the capsules filled with liquid: 50<Tₐ<100° C.; 0<T_{c}<30° C., 30 T_{f}<90° C.; 50 T_{w}<100° C.; 50<Tₖ<100° C.

In relation to the present invention it is necessary that the starches used form, from hot aqueous solution, after cooling therefrom, the elastic gel phases having a modulus E>0.1 MPa, elongation and tensile stress at break 1.5 and >0.1 MPa in the stretching test (stretching rate 0.1 in 10 seconds) at 20° C. after a useful residence time in the cold state. The time periods, solution compositions and temperatures not mentioned here are given by the description of the parameters of the process. For the invention described, a formation as rapidly as possible of the elastic gel phase in the aqueous starch solutions is therefore advantageous. The inventors of the present application have surprisingly found that solutions of starches which, under the process parameters given above, permit the use of the pin-dipping process, may be characterized by chemical structure data and by phase structure parameters:

The starch constituent of the inventive soft capsules can be any starch or a mixture of two or more thereof, one or more derivatives thereof or mixtures of starch and starch derivatives.

Suitable starch examples are starch from potatoes, tapioca, manioc, rice, wheat or corn. Other examples are starches from arrowroot, sweet potato, rye, barley, millet, oats, sorghum, starches from fruits such as chestnuts, acorns, beans, peas and other legume fruits, bananas and plant pith, for example of sago palms. They can either chiefly comprise amylose or amylopectin, that is to say the content of predominant component is greater than 50% based on the total content of amylose and amylopectin in the starch. The starch can be hydrothermally and/or mechanically pretreated.

In addition to starches of plant origin, starches can also be used which are chemically modified, have been produced by fermentation, are of recombinant origin or have been produced by biotransformation or biocatalysis.

“Chemically modified starches” are taken to mean in the invention those starches in which, chemically, the properties have been changed in comparison with the natural properties. This is essentially achieved by polymer-analogous reactions, in which starch is treated with monofunctional, bifunctional or polyfunctional reagents or oxidizing agents. In this treatment, preferably the hydroxyl groups of the poly-α-glucans of the starch are converted by etherification, esterification or selective oxidation, or the modification is based on a free-radical initiated graft copolymerization of copolymerizable unsaturated monomers onto the starch backbone.

Particular chemically modified starches include, inter alia, starch esters, such as xanthogenates, acetates, phosphates, sulfates, nitrates, starch ethers, for example nonionic, anionic or cationic starch ethers, oxidized starches, for example dialdehyde starch, carboxyl starch, persulfate-degraded starches and similar substances.

Preferred chemical modifications comprise hydroxypropylation, acetylation and ethylation.

“Fermentation starches” are, in the terminology of the invention, starches which can be produced by fermentation processes using organisms occurring in nature, such as fungi, algae or bacteria, or can be produced with the inclusion and aid of fermentation processes. Examples of starches from fermentation processes comprise, inter alia, gum arabic and related polysaccharides (gellan gum, gum ghatti, gum karaya, gum tragacanth), xanthan, emulsan, rhamsan, wellan, schizophyllan, polygalacturonates, laminarin, amylose, amylopectin and pectins.

“Starches of recombinant origin” or “recombinant starches” means here starches which can be produced by fermentation processes using organisms which do not occur in nature, but using natural organisms modified by genetic engineering methods, such as fungi, algae or bacteria, or can be obtained with the inclusion and aid of fermentation processes. Examples of starches from genetically modified fermentation processes are, inter alia, amylose, amylopectin and other poly-α-glucans.

“Starches produced by biotransformation” means in the context of the invention that starches, amylose, amylopectin or poly-α-glucans are produced by catalytic reaction of monomeric building blocks, generally oligomeric saccharides, in particular monosaccharides and disaccharides, by using a biocatalyst (also: enzyme) under specific conditions. Examples of starches from biocatalytic processes are, inter alia, polyglucan and modified poly-α-glucans, polyfructan and modified polyfructans.

According to the invention, the terms “derivatives of starches” or “starch derivatives” mean quite generally modified starches, that is to say those starches in which, to change their properties, the natural amylose/amylopectin ratio has been changed, a pregelatinization has been carried out, which have been subjected to partial hydrolytic degradation, or have been chemically derivatized.

Particular derivatives of starches include, inter alia, oxidized starches, for example dialdehyde starch, or other oxidation products containing carboxyl functions, or native ionic starches (for example containing phosphate groups) or further ionically modified starches, not only anionic but also cationic modifications coming under this term.

In addition to the constituents acting as gelation agent, the inventive gel comprises a plasticizer or solvent, with mixtures also being able to be used here, as swelling agent.

Examples of suitable swelling agents are water, polyalcohols such as ethylene glycol, glycerol, propanediol, erythritol, mannitol, sorbitol, polybasic alkanoic acids such as maleic acid, succinic acid, adipic acid, polybasic hydroxyalkanoic acids such as lactic acid, 2-hydroxybutyric acid, citric acid, malic acid, dimethyl sulfoxide, urea or other starch solvents.

Under a preferred aspect of the present invention, the ratio of the weight fraction of non-native, biotechnologically produced, water-insoluble linear poly-α-glucan to starch in the gel or in the soft capsule is 1% to 50%, in particular 1.01% to 30%, and the ratio of the weight fraction of polyglucan and starch to swelling agent is generally in the range from 1% to 60%.

Under a further preferred aspect of the present invention, the ratio of the weight fraction of debranched starch to native starch is 1% to 50%, in particular 1.01 % to 30%, and the ratio of the weight fraction of debranched starch and native starch to swelling agent is generally in the range from 1% to 60%.

Generally, the weight fraction of the less branched component is less than that of the more highly branched component(s). This weight fraction is 1% to 50%, preferably 1.01 to 30%. In a mixture of non-native, biotechnologically produced, water-insoluble linear poly-α-glucan, debranched starch and native starch, this means that the non-native, biotechnologically produced, water-insoluble linear poly-α-glucan makes up at most 50% of the total carbohydrates. For the two other components, in this case, the content of the native starch shall preferably predominate over that of the debranched starch.

Under a further preferred aspect, the present invention, however, also relates to soft capsules comprising solely debranched starch.

Depending on the components used in a specific case or particular application, these values can also vary upward or downward.

The term “soft capsule” shall according to the invention mean the products known in the prior art of continuous and semicontinuous production processes for one-part capsules. In particular, these soft capsules should be suitable for encasing constituents which are pumpable, liquid in the broadest sense, in contrast to hard capsules which are generally produced after mixing the support material with, for example, pulverulent or high-viscosity constituent, and compressing this mixture.

The examples below describe the invention in more detail. However, they should be understood not to be limiting.

### EXAMPLE 1

Novelose 330, from National Starch and Chemical Corporation, Wilmington, Del., was used. Dp(N), f_{crystalline} and Q_{branch} were determined for the starch sample used and shown in table 1. The device for producing the capsules was equipped with shaping rolls which were equipped with recesses for receiving the capsule halves in oval shape. The 10 recesses on each roll each had a length of 3 cm, a width of 1.5 cm and a depth of 0.75 cm. The solution (a), prepared from 90 g of Novelose, 10 g of glycerol and 900 g of water was made up at 100° C. and kept for 2 hours at 90° C. The temperatures were set, the vessel (A) of the starch solution (a) was 90° C.; Tc=3° C.; Tf=70° C.; Tk=90° C. Strips were cut from the capsule halves and characterized in a simple tensile test at 20° C. (see table 1).

### EXAMPLE 2

Instead of Novelose, Hylon VII was used and otherwise the procedure of example 1 was followed.

### EXAMPLE 3

Instead of Novelose, Amylogel 3003 was used, and otherwise the procedure of example 1 was followed.

### COMPARATIVE EXAMPLE 1

Instead of Novelose®, debranched amylopectin was used and otherwise the procedure of example 1 was followed.

### COMPARATIVE EXAMPLE 2

Instead of Novelose, potato starch Amyloplast PE 004 from Amylum SA Aalst, Belgium was used, and otherwise the procedure of example 1 was followed.

TABLE 1

| | | | | | Tensile | Elonga- |
|---|---|---|---|---|---|---|
| | | | | Dp | stress | tion |
| Starch | | f_{crystalline} | Q_{branch} | (N) | [MPA} | at break |
| 1. | Novelose ® 330 | 0.30 | 5 × 10⁻⁴ | 2 000 | 30 | 0.5 |
| | Hylon ® VII | 0.17 | 2 × 10⁻³ | 3 500 | 20 | 0.2 |
| | Amylogel ® 3003 | 0.15 | 2 × 10⁻³ | 4 500 | 20 | 0.2 |
| 2. | Amylopectin, | 0.35 | 2 × 10⁻⁴ | 80 | * | * |
| | debranched | | | | | |
| 3. | Amyloplast ® | 0.02 | 10⁻² | 4 000 | * | * |

*= no films could be produced.

The results show that using debranched starch of the type described and native starch of high amylose content >70%, corresponding soft capsules can very readily be produced. Debranched amylopectin, owing to the molecule lengths which are too short, results in no films, likewise native starch does not, owing to the excessive degree of branching and the insufficient content of crystalline structures.

1. A soft capsule comprising a gel of a starch mixture and a swelling agent, where the starch mixture comprises at least one starch component which has a reduced degree of branching compared with native starch, and where the starch mixture can in addition also have native starch, characterized in that at least one of the starch components has a Dp(N) of >100.

2. The soft capsule as claimed in claim 1 in which the starch mixture is a mixture of native starch and non-native, biotechnologically produced, water-insoluble and linear poly-α-glucan, and in which the ratio of the weight fractions of poly-α-glucan to native starch is in the range from 1% by weight to 50% by weight.

3. The soft capsule as claimed in claim 1 in which the starch mixture is a mixture of debranched starches, and in which the starting starch can be a homogeneous amylose/amylopectin mixture from a natural source or a mixture of starch components from different sources.

4. The soft capsule as claimed in claim 1 in which the starch mixture is a mixture of debranched starches and native starches, and in which the ratio of the weight fractions of debranched starch to native starch is in the range from 1% by weight to 50% by weight.

5. The soft capsule as claimed in claim 1 in which the starch mixture is a mixture of non-native, biotechnologically produced, water-insoluble and linear poly-α-glucans and debranched starches.

6. The soft capsule as claimed in claim 1 in which the starch mixture is a mixture of non-native, biotechnologically produced, water-insoluble and linear poly-α-glucans, debranched starches and native starches, and in which the ratio of the weight fractions of poly-α-glucan and debranched starches to native starch is in the range from 1% by weight to 50% by weight.

7. The soft capsule as claimed in one of claims 1, 2, 5 or 6, characterized in that the poly-α-glucan is poly-α-1,4-D-glucan.

8. The soft capsule as claimed in one of the preceding claims, characterized in that the linear poly-α-glucan was produced biocatalytically using an amylosucrase.

9. A soft capsule made of a gel of native starch having a high amylose content >70% by weight and a swelling agent.

10. The soft capsule as claimed in one of the preceding claims, characterized in that the gel has a ratio of the parts by weight of all carbohydrates to swelling agent in the range from 1 % to 60%.

11. The soft capsule as claimed in one of the preceding claims, characterized in that the underlying gel can comprise as swelling agent at least one plasticizer which is selected from the group consisting of water, ethylene glycol, glycerol, propanediol, erythritol, mannitol, sorbitol, maleic acid, succinic acid, adipic acid, lactic acid, 2-hydroxybutyric acid, citric acid, malic acid, dimethyl sulfoxide and urea.

12. The soft capsule as claimed in one of the preceding claims, characterized in that the underlying gel is edible and/or biodegradable.

13. The soft capsule as claimed in one of the preceding claims, characterized in that the gel comprises further substances modifying odor and/or taste and/or color of the soft capsules, and other additives as are customary for the respective application.

14. The soft capsule as claimed in one of the preceding claims, characterized in that it comprises substances or mixtures of substances which are pharmacologically active, active in veterinary medicine, cosmetically active or agrochemically active.

15. The soft capsule as claimed in one of the preceding claims, characterized in that it is suitable for use in the food and drink industry, medicine/pharmacy, veterinary medicine and agrochemistry.

16. A process for producing soft capsules as claimed in one of the preceding claims, in which starch mixture and swelling agent are homogenized at temperatures >160° C., the gel produced is thermoformed in a suitable processing method to give a sheet, a film or a strip, and the soft capsule is then produced by the rotary die process.

17. The use of a gel as claimed in one of claims 1 to 9 for producing soft capsules.
